(19) United States
(12) Patent Application Publication
(10) Pub. No.: US 2005/0056628 A1
(43) Pub. Date: Mar. 17, 2005

(54) Coaxial nozzle design for laser cladding/welding process

(76) Inventor: Yiping Hu, Greer, SC (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/665,028

(22) Filed: Sep. 16, 2003

(51) Int. Cl. B23K 26/14

(52) U.S. Cl. 219/121.84; 219/121.63

(57) ABSTRACT

A laser nozzle for use in a laser powder fusion (LPF) welding process provides longer service life and ease of maintenance. Eliminating the use of laser nozzle inserts, the laser nozzle uses an inner tip that is less subject to damage from the welding process. The laser beam travels down an open central passage to exit out the inner tip in focused alignment with a conical powder flow stream ending in a point generally coincident with the laser beam. The powder supply travels through a passage that is generally coaxial to the central laser passage. A circumscribing passage for inert shielding gas or the like is coincidentally coaxial with both the laser powder flow channel and the central laser channel. Coolant is circulated through a main body portion of the nozzle in order to keep the entire assembly cool. Both the laser and the flow of powder may be adjusted according to operating preferences. A porous shielding cover prevents ejecta and other materials from entering into the shielding gas flow channel. The entire assembly is easily constructed from readily available materials and is easily disassembled for cleaning. Reassembly is also easily achieved in order to enable rapid refurbishment and reconstitution of an optimal LPF welding nozzle.

### CROSS-REFERENCES TO RELATED APPLICATIONS

This patent application incorporates by reference, but claims no priority to the following patents and regular and provisional patent applications:

U.S. patent application Ser. No. 10/071,025 filed Feb. 8, 2002 for Hand Held Laser Powder Fusion Welding Torch; and

U.S. patent application Ser. No. 10/206,411 filed Jul. 26, 2002 for Powder Feed Splitter for Hand-Held Laser Powder Fusion Welding Torch.

### COPYRIGHT AUTHORIZATION

Portions of the disclosure of this patent document may contain material which is subject to copyright and/or mask work protection. The copyright and/or mask work owner has no objection to the facsimile reproduction by anyone of the patent document or the patent disclosure, as it appears in the Patent and Trademark Office patent file or records, but otherwise reserves all copyright and/or mask work rights whatsoever.

### BACKGROUND OF THE INVENTION

1. Field of the Invention

This invention relates to powder fusion welding and more particularly to a coaxial nozzle for use in laser powder fusion welding (LPFW) processes.

2. Description of the Related Art

In general, the surface of a metallic article may be welded and/or alloyed by the simultaneous and cooperative operation of a laser beam and an alloy powder stream. To accomplish this, systems exist that have a laser source and focusing apparatus, with a powder delivery apparatus provided as part of an integral package. The laser beam melts a relatively small area at the surface of the article, and a controlled volume of alloying particles are delivered into the melt pool via the powder flow stream.

In laser fusion welding, an article of metal or other material may have the surface thereof alloyed, or otherwise treated, by the simultaneous and cooperative operation of a laser beam with an alloy powder. Typically, the laser beam melts a relatively small volume of the outer surface of the article and the powder feeding system delivers a controlled volume of alloying particles into this molten pool. The alloying particles become dispersed throughout this pool and therewith alter, complement, or add to the composition of the outer layer in a controllable way. Removal of the beam, such as by advancement of the workpiece relative to the laser beam, can cause the molten metals to be rapidly cooled. The cooling can occur so rapidly that the clads or welds retain the characteristics of the molten metal.

With the increased use of lasers to provide free-form powder fusion welding, articles can be constructed having near-net shape. This provides significant advantages as compared to casting or other component-making processes.

In a powder fusion process, powder filler material is fed to the irradiated area of the welding tool, usually a laser or other energy source. The powder may contain a variety of different substances including particulate metals and composites. Generally, a powder feeder is used to deliver the filler powder to the welding torch. In some cases, the powder flow stream is split into several substreams and transported to the welding torch through several different flow trajectories in order to form cone-shaped powder stream outside the welding torch. The filler powder is generally delivered to the welding torch by a pressurized gas, such as an inert or non-reactive gas such as helium and argon.

As an example, gas turbine engines, such as those utilized with jet aircraft, are being designed with ever increasing performance requirements. Laser powder fusion (LPF) technology has been in use for the past several years and has demonstrated benefits by welding previously unweldable materials and on small heat affected zones on turbine airfoils. Other parts and machines can also benefit from the use of LPF technology. However, there have been some drawbacks in certain elements in LPF welding systems, including the nozzle that serves to bring together both the laser light that performs the welding as well as the powder which is used to construct the weld. Such nozzles often provide a circumscribing “curtain” of flowing inert gas which temporarily and effectively shields the weld site from oxygen and other gasses and materials, which can interfere with the welding process and/or the integrity of the resulting weld.

Some known nozzle designs have many drawbacks. For example, nozzle inserts used in some nozzles may easily burn, may take an undue amount of time to replace the inserts or to align the beam, and/or the overall function is not consistent. Such nozzles are generally not suited for many applications.

For some prior nozzles, the bottom edge of the inner insert is so thin or sharp that it may not tolerate heat reflected from the welding zone. Therefore, the inner insert may be damaged during the laser welding process. This may be especially noticeable when welding on an inclined surface where severe laser beam reflection occurs. It can take a few hours or more to replace such nozzle inserts which can be costly.

In some cases, the inner insert sustains only minor damage. For example, the edge may fold outwards slightly due to the cleaning process or otherwise. This minor damage does not affect the powder feed rate, but it does change the powder stream shape, which should be cone-shaped at the nozzle exit. Such damage can also reduce the powder utilization efficiency, since less powder may flow to the welding zone. This can lead to two possible results, both of which are unacceptable: the weld is hot and material buildup is less, and/or cracking is created inside the weld. Because such prior nozzles' performance are not consistent, delays in production may occur that increase production time by days.

In addition, a shielding plate may play an important role in the laser welding process. The shielding plate in some prior nozzles is made of sintered copper with micropores. During the laser welding process, molten particles or plasma fumes may seal the micropores and make the nozzle's function inconsistent and unreliable.

In view of the several disadvantages present in current laser nozzles, additional costs and time are spent in order to accommodate the frequent failures that arise when such prior laser nozzles are actually used in welding processes. These shortcomings in prior laser nozzles have acted as an impediment to laser welding processes and the advancement of the laser powder fusion welding arts. As laser powder fusion welding provides reliable means by which near-net parts can be achieved as well as repairing parts that would otherwise be scrapped or discarded, there is a need in the art to provide a laser powder fusion welding nozzle that can better withstand the welding operations for which it is designed.

In view of the foregoing disadvantages, there is a need for an improved laser powder fusion welding nozzle that operates in a reliable and robust manner with a tip that does not fail on a recurring basis. It would also be advantageous to have such a laser powder fusion welding nozzle that did not suffer injury or damage during the welding process which leads to asymmetrical powder feeding into the irradiated area. The present invention solves one or more of these disadvantages and satisfies a need for better laser powder fusion welding nozzles that is presently in the art.

### SUMMARY OF THE INVENTION

In view of the foregoing disadvantages, the present invention provides a laser powder fusion welding nozzle wherein the nozzle can be used for a longer period of time in welding processes and the like. In particular, a new laser powder fusion welding nozzle is provided that does not require the replacement of nozzle inserts, does not as frequently sustain nozzle tip deformation, and provides more reliably-symmetric powder flow, overcoming several of the disadvantages present in the prior art by combining many novel features in order to achieve a new laser powder fusion welding nozzle design.

Knowledge and experience in the field of laser cladding/welding process has led to the present design. Compared with prior nozzles, the present nozzle design has the following advantageous features: it is easy to clean inside the nozzle; it provides better shielding during laser welding; it eliminates the use of nozzle inserts; the powder stream interacts with laser beam outside the nozzle; it is easy to adjust the laser focus distance in order to get different laser spot sizes; and it is easy to adjust the positioning of cone-shaped powder stream with respect to the center of laser beam.

Because nozzle inserts are not used in the present nozzle design, the nozzle does not need replacement and beam alignment that would arise from use of such inserts. The new nozzle design has many advantages (mentioned above) over prior nozzles which are believed to enable nozzle performance that is significantly advanced.

The laser powder fusion welding nozzle has a variety of coaxial features that generally center upon the linear axis on which the laser beam travels. Conveniently, the central passageway of the nozzle through which the light travels provides enough radial space to enable laser beams of different cross sections to constructively use the nozzle.

The main body has cut into it a coolant chamber through which coolant may flow. This coolant channel is covered by a coolant jacket or water jacket cover that is detachably attached to the top of the main body by fasteners such as screws. The coolant jacket cover has indentations or depressions in oppositely opposed or orthogonal pairs in which powder tubes rest. The powder tubes communicate with powder conduits that travel through the main body and exit out the other side. The main body is pointed in a stepwise fashion ending in a final terminal end about which the inner tip detachably attaches as by threaded engagement, or otherwise. Although the materials used are preferably of the type like copper alloy, detachable attachment as by threaded engagement is very convenient as it provides for separation for the necessary channels (described below) while allowing easy disassembly and reassembly for cleaning and reconfiguration.

The intermediate step of the main body is circumscribed by an outer nozzle. While the laser light travels through the central passage of the main body and the inner tip, the area between the inner tip and outer nozzle provides a channel through which powder can flow as this powder flow channel is in communication with the powder conduits of the main tip. Circumscribing the entire main body nozzle assembly is a housing which acts as an outer gas containment sleeve and provides a shield gas flow channel between its interior and the exterior of the outer nozzle. The housing is attached to the main body by screws or the like. Inlets are present at the sides of the containment sleeve for the introduction of shield gas, generally an inert gas.

In order to protect the welding zone, inert gas flows through a porous shielding cover. The porous shielding cover better distributes to provide more uniform distribution of the inert gas. The porous shielding cover is held in place by a snap ring which fits into a groove engraved at the mouth of the housing.

A body O-ring provides a seal between the main body and the housing. Inner and outer coolant jacket O-rings are present to provide positive seals for the coolant channel in the main body. The O-rings are generally made of BUNA-type rubber.

In one embodiment, the laser nozzle for powder feed laser welding has an inner tip that resists damage arising from heat generated during a welding process. An outer nozzle circumscribing the inner tip in spaced apart relationship defines a circumscribing powder flow channel about the inner tip. An housing circumscribes the outer nozzle in spaced apart relationship to define a circumscribing shield gas flow channel about the outer nozzle such that the laser nozzle enjoys a longer useful life and provides more efficient welding as the inner tip is less susceptible to damage from the welding process.

In another embodiment, the laser nozzle for powder feed laser welding has a detachable inner tip that resists damage arising from heat generated during a welding process. A detachable outer nozzle circumscribes the inner tip in spaced apart relationship to define a circumscribing powder flow channel about the inner tip. A detachable housing circumscribes the outer nozzle in spaced apart relationship to define a circumscribing shield gas flow channel about the outer nozzle. A main body couples the inner tip, the outer nozzle and the housing. The main body defines a central passage through which light may travel, defines a powder flow conduit in communication with the powder flow channel, and defines a coolant channel coaxial with the central passage. A detachable water jacket cover couples to the main body and encloses the coolant chamber to prevent coolant leakage. The water jacket cover defines a powder tube depression through which a powder tube may pass and communicate with the powder flow conduit. A detachable porous shielding cover is coupled to and circumscribes the outer nozzle. The porous shielding cover allows gas to exit from the shield gas flow channel in a more uniform manner. The porous shielding cover is circumscribed by and is coupled to the housing such that the laser nozzle is easier to clean and maintain and enjoys a longer useful life and provides more efficient welding as the inner tip is less susceptible to damage from the welding process.

In another embodiment, the coaxial nozzle for laser powder fusion (LPF) welding has a main body defining a central light passage through which light may pass through the main body. The main body defines a powder conduit through which powder may pass through the main body. The main body defines a coolant channel through which coolant may flow, the coolant chamber coaxial with the central light passage and circumscribing the powder conduit. A coolant jacket cover detachably attaches to the main body and seals the coolant channel, the coolant jacket defining an inlet and an outlet to the coolant channel. An inner tip defines a first central open channel through which light may pass, the inner tip detachably attached to a terminal end of the main body. The inner tip is coaxial with the central light passage of the main body. An outer nozzle defines a second central open channel through which powder may pass, the outer nozzle detachably attached to the main body. The outer nozzle is coaxial with the first central open channel of the inner tip and the central light passage of the main body. A powder flow channel is defined between the outer nozzle and the inner tip and is in communication with the powder conduit. A housing defines a third central open channel through which inert gas may pass, the housing detachably attached to the main body. The housing is coaxial with the second central open channel and the first central open channel and the central light passage. A shield gas flow channel is defined between the outer nozzle and the housing. A detachable porous shielding cover circumscribes a terminal end of the outer nozzle and covers an open end of the shield gas flow channel.

In another embodiment, a nozzle for powder feed laser welding has a detachable and heat-resistant tip that resists damage arising from heat generated during operation, the tip having a first central light passage. The nozzle defines a second central light passage aligned and communicating with the first central light passage. The nozzle defines a powder flow passage circumscribing and coaxial with the central light passage. The nozzle defines a shield gas flow passage circumscribing and coaxial with the powder flow passage and the central light passage. A detachable porous shielding cover covers an open end of the shield gas flow passage proximate the tip.

Other features and advantages of the present invention will become apparent from the following description of the preferred embodiment(s), taken in conjunction with the accompanying drawings which illustrate, by way of example, the principles of the invention.

### BRIEF DESCRIPTION OF THE DRAWINGS

FIG. 1 is a vertically exploded view of the laser powder fusion (LPF) welding nozzle, the drawing exploded along the central vertical axis.

FIG. 2 is a first side elevational view of the LPF nozzle of FIG. 1 as assembled.

FIG. 3 is a second side elevational view of the LPF welding nozzle of FIG. 2.

FIG. 4 is a side cross sectional view of the LPF welding nozzle of FIG. 3 taken along the line 4-4 of FIG. 3.

FIG. 5 is a top side perspective view of the LPF nozzle of FIG. 2.

FIG. 6 is a bottom side of the LPF welding nozzle in FIG. 2.

FIG. 7 is a bottom plan view of the LPF welding nozzle of FIG. 2.

FIG. 8 is a top plan view of the LPF welding nozzle of FIG. 2.

### DESCRIPTION OF THE PREFERRED EMBODIMENT(S)

The detailed description set forth below in connection with the appended drawings is intended as a description of presently-preferred embodiments of the invention and does not represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

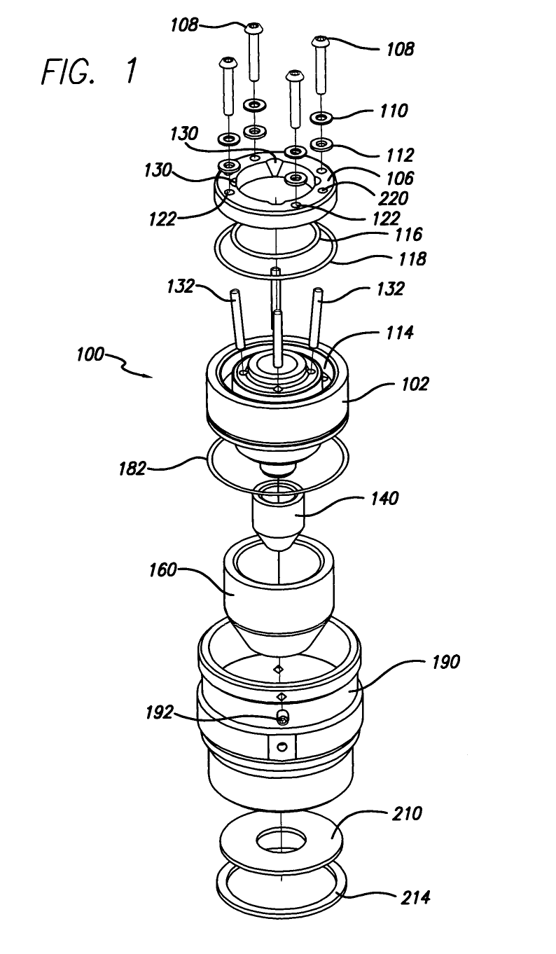

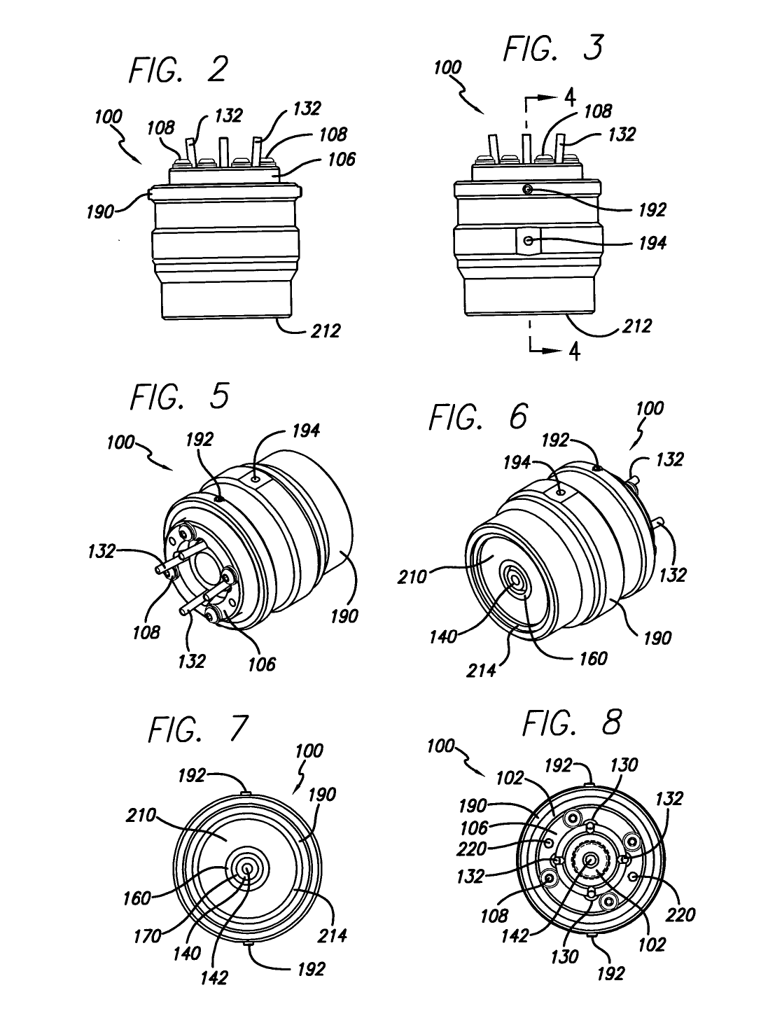

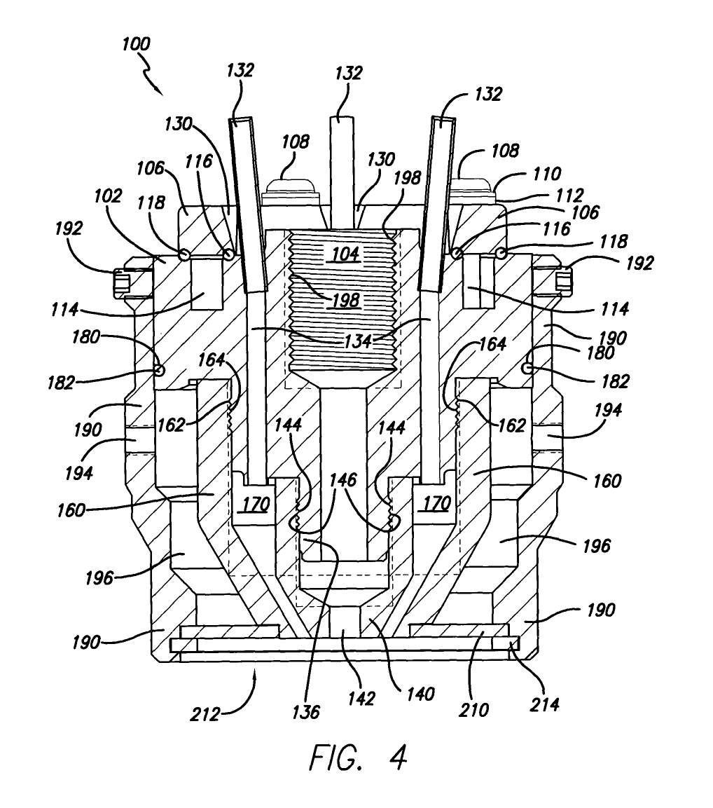

As best shown in FIGS. 1 and 4, the coaxial laser powder fusion (LPF) welding nozzle 100 has a main body 102 which generally serves as a core element and helps to receive and guide both the powder used for laser fusion (not shown) as well as having a central channel 104 through which the laser light passes. The main body 102 is capped or covered by a coolant jacket cover 106 which detachably attaches to the main body 102 by means of fasteners 108. A flat washer 110 and a BUNA washer 112 circumscribe the fasteners 108 in order to provide a seal for the fastener holes 122 passing through the coolant jacket cover 106 which seals the coolant chamber 114 cut into the main body 102. An inner coolant jacket cover O-ring 116 and an outer coolant jacket cover O-ring 118 served to provide a positive seal between the coolant jacket cover 106 and the main body 102 over the coolant channel 114.

BUNA N or Nitrile is a copolymer of butadiene and acrylonitrile and may be used to construct the BUNA washer 112. On the whole, most of the parts are generally made of copper alloys or other resilient material. The main body 102, the coolant jacket cover 106, and the housing 190 may be made of brass. The inner tip 140 and the outer nozzle 160 may be made of copper. The body O-ring 182 and the inner 116 and outer 118 coolant jacket cover O-rings may be made of BUNA rubber. The flat washer 110, fasteners 108, powder tubes 132, and screws 192 may be made of stainless steel. A coolant jacket cover 106 has indentations or depressions 130 into which powder tubes 132 fit. The powder tubes 132 are inserted into and communicate with powder conduits 134 which travel through the main body 102.

As shown particularly in FIGS. 1 and 4, the main body 102 has a pointed configuration achieved in a stepwise fashion. As shown in FIG. 4, the main body 102 may be considered as having a top cylindrical portion with a wider radius, a middle cylindrical portion having a smaller radius and an inner portion having the smallest radius. The terminal projection 136 circumscribes a continuation of the central channel 104 and is itself circumscribed by the inner tip 140 which circumscribes its own tip channel 142 that enables the laser light passing through the central channel 104 to exit the nozzle 100. The inner tip 140 may detachably attach to the terminal projection 136 by threaded engagement or otherwise with the terminal projection 136 having threads 144 circumscribing its base into which matching threads 146 which circumscribe the top interior of the inner tip 140 may fit. The inner tip 140 is detachably attachable to the main body 102 at the terminal projection 136 thereof.

Circumscribing the middle portion of the main body 102 is an outer nozzle 160 which also has inner threads 162 circumscribing the inner top surface of the outer nozzle 160. The threads of the outer nozzle 160 may engage matching outer threads 164 that circumscribe the base perimeter portion of the middle portion of the main body 102. The outer nozzle 160 may detachably attach to the middle portion of the main body 102 by means of a threaded engagement or otherwise provided between the matching threads 162, 164.

The inner tip 140 is radially inside of the powder conduits 134 and is closer to the central channel 104 than the powder conduits 134. Consequently, the inner tip 140 does not interfere with the flow or egress of powder through the powder tubes 132 or the powder conduits 134. The powder conduits 134 communicate with a plenum space or channel 170 defined between the inner tip 140 and the outer nozzle 160. This plenum space is defined by the surfaces of the inner tip 140 and the outer nozzle 160. Fluid flow, including the flow of fusion powder, from the powder flow channel 170 may be focused on the main axis and light travel path passing through the central channel 104. As the powder flow channel 170 is coaxial with the central channel 104 and its vertical axis, and as the laser light will travel generally along this vertical axis centered on the central channel, powder traveling through the powder flow tubes 132 powder conduits 134 and powder flow channel 170 will generally be coincident with the laser light at some location beyond the LPF nozzle 100. This location, which may be referred to as the powder flow convergent point, will be generally and immediately in front of the inner tip 140 and its tip channel 142. Adjustment of the powder flow focal point may be achieved by proper selection and geometry of the inner tip 140 and the outer nozzle 160.

Engraved in the side of the main body 102 is a groove 180 into which a body O-ring 182 fits. The O-ring 182 serves to provide a seal between the main body 102 and the housing 190. The housing 190 may serve as a holder for the main body 102 as well as an envelope within which shield gas may flow which shields the welding operation that takes place in front of the tip channel 142. The housing 190 may also serve as a mechanical support and point of attachment for the nozzle 100 to a laser system, powder feed system, cooling system, and the like. However, an automated welding system or other control system (not shown) may attach by threaded engagement of the inside of the main body 102 along the inside surface 198 of the central channel 104.

The housing 190 attaches to the main body 102 by means of screws 192 placed near the top of the containment sleeve 190 as shown in FIG. 4 or otherwise. A connector or other device may be used to connect a gas supply to the containment sleeve 190. Inlets 194 allow the pressurized flow of inner shielding gas or the like to travel into the confines of the containment sleeve 190. The outer nozzle 160 serves as the inside of the shield gas flow channel 196 which has its exit near the mouth of a nozzle 100 circumscribing the outer nozzle 160 as well as the powder flow channel 170. A porous shielding cover 210 covers the exit of the shield gas channel 196 and helps to ensure that ejecta or other material from the welding site does not enter into the shield gas channel 196. The porous shielding cover enables the shield gas to flow through it and onto the welding site in order to protect the welding site from oxidation but does not allow the reverse passage or flow of ejecta or other material back into the shield gas flow channel 196. The porous shielding cover 210 is held in the groove etched into the mouth 212 of the nozzle 100 by a snap ring 214 which likewise fits into its own groove machined into the mouth 212 of the nozzle 100. A corresponding groove opposite that engraved in the containment sleeve 190 for the porous shielding cover 210 may be present in the outer nozzle 160. The porous shield and cover 210 is held in place by the snap ring 214 between the outer nozzle 160 and the housing 190.

In order to dismantle the LPF welding nozzle 100, the snap ring 214 may be disengaged from the housing 190 thereby freeing the porous shielding cover 210. The porous shielding cover 210 is then removed. The clamping screws 192 are then loosened by unthreading them slightly from the housing 190. The main body 102 may then be removed from the housing 190. The outer nozzle 160 and the inner tip 140 may be removed as by unthreading from the main body 102. The body O-ring 182 may be removed from its groove 180 and the fasteners 108 may be unthreaded from the main body 102. This frees the coolant jacket cover 106 from the main body 102 and the inner 102 and outer 118 coolant jacket cover O-rings maybe freed from their seats. Prior to removal of the coolant jacket cover 106, the powder tubes 132 may be unseated from their inserted positions in the main body 102. The outward cant of the powder tubes 132 may prevent the removal of the coolant jacket cover 106. A friction fit may be present by the powder tubes 132 into the main body 102 or more permanent means of fixing the powder tubes 132 to the main body 102 may be used. However, permanent fixation of the powder tubes may interfere with the disassembly of the coolant system.

Assembly of the nozzle 100 may be achieved by a general reversal of the disassembly sequence set forth above or by a general inspection of the figures.

Having set forth the construction and structure of the nozzle 100, its operation is set forth below. The nozzle 100 is connected to a laser powder fusion (LPF) welding system such that the laser light of the welding system passes through the central channel 104 and out the inner tip 140 through the tip channel 142. This laser light is sufficient to melt or alter either or both the substrate material upon which the weld is to be performed and/or the powder fusion material passing through the nozzle 100.

The powder fusion material is generally propelled by pressurized inert gas, generally the same inert gas that is pumped through the shield gas flow channel 196. Inert gases are used so that they do not react with the powder or the substrate material at the weld site. The powder material enters into the nozzle through the powder tubes 132, travels through the powder conduits 134, flow into the powder flow channel 170 and then exits the mouth 212 of nozzle 100 in a generally conical fashion circumscribing the tip channel 142 of the inner tip 140.

When the filler material exiting out the powder flow channel 170 meets the laser light, it is melted and then may fuse with the spot melt present at the weld site to augment the material pooling there. The weld site with its melt pool is shielded from chemical reaction by an inert ambient environment provided by the flow of inert gas through the shield gas flow channel 196 and its exit through the porous shielding cover 210 as it exits out of the mouth 212 of the nozzle 100. The porous shielding cover 210 generally provides for uniform distribution and diffusion of the inert shielding gas without significant turbulence. Sufficient shielding gas volume should be provided to ensure that the hot weld area does not react with ambient gases or otherwise.

During the welding operation, heat is generated that may be transmitted to the nozzle 100.

In order to keep the nozzle 100 cool, coolant is circulated within the main body 102 in the coolant channel 114. Coolant inlets 220 are present in the top of the coolant jacket cover 106 and allow the entrance and exit of coolant, particularly water, into and out of the coolant channel 114. The circulation of coolant in the coolant channel 114 enables the main body 102 to be kept cool and to endure longer and/or hotter welding operation sessions.

Note should be taken that the embodiment set forth above is only one of several possible embodiments of the present system that enable the use of a more robust tip to prevent the ongoing and inconvenient replacement of nozzle inserts and the like in order to provide longer operation of the nozzle 100 without suffering interruption. In other embodiments, both inner tip 140 and outer nozzle 160 may be replaced by ones having a different or differently distributed powder flow convergent point in order to select such a convergent point and center of operation for welding using the nozzle 100. This may also entail a changing of the porous shield cover 210. However, with the snap ring 214 enabling quick replacement of the porous shielding cover 210 and the outer nozzle 160, this operation should result in minimal down time for the laser welding device. Additionally, use of the nozzle 100 is not limited to any particular type of laser. The central channel 104 allows the passage of almost any wavelength of light that could be used to energetically excite the welding site.

The present laser nozzle set forth here provides many advantages beyond those laser nozzles previously known. The nozzle 100 eliminates the use of easily-damaged nozzle inserts in order to provide greater up time for welding operations. Additionally, the laser nozzle 100 may be easily dismantled for cleaning purposes and then easily reassembled for quick use for LPF systems. The materials used to create the parts of the nozzle 100 are readily available and machinable in order to obtain a laser nozzle according to the description set forth herein. Consequently, LPF welding operations are made more reliable, predictable, easier, and less subject to interruption by part failure arising in the nozzle.

While the present invention has been described with reference to a preferred embodiment or to particular embodiments, it will be understood that various changes and additional variations may be made and equivalents may be substituted for elements thereof without departing from the scope of the invention or the inventive concept thereof. In addition, many modifications may be made to adapt a particular situation or material to the teachings of the invention without departing from the essential scope thereof. Therefore, it is intended that the invention not be limited to particular embodiments disclosed herein for carrying it out, but that the invention includes all embodiments falling within the scope of the appended claims.

1. A laser nozzle for laser powder fusion welding, comprising:
an inner tip that resists damage arising from heat generated during a welding process;
an outer nozzle circumscribing the inner tip and spaced apart there from to define a powder flow channel there between; and
a housing circumscribing the outer nozzle in spaced apart relationship to define a circumscribing shield gas flow channel about the outer nozzle.

2. A laser nozzle for laser powder fusion welding as set forth in claim 1, further comprising:
a main body coupling the inner tip, the outer nozzle and the housing, the main body defining a central passage through which light may travel, the main body defining a powder flow conduit in communication with the powder flow channel, the main body defining a coolant channel coaxial with the central passage.

3. A laser nozzle for laser powder fusion welding as set forth in claim 2, further comprising:
a water jacket cover coupled to the main body and enclosing the coolant channel to prevent coolant leakage, the water jacket cover defining a powder tube depression through which a powder tube may pass and communicate with the powder flow conduit.

4. A laser nozzle for laser powder fusion welding as set forth in claim 2, further comprising:
a porous shielding cover coupled to and circumscribing the outer nozzle, the porous shielding cover allowing gas to exit from the shield gas flow channel and preventing entry of material into the shield gas flow channel, the porous shielding cover circumscribed by and coupled to the housing.

5. A laser nozzle for laser powder fusion welding, comprising:
a detachable inner tip that resists damage arising from heat generated during a welding process;
a detachable outer nozzle circumscribing the inner tip in spaced apart relationship to define a circumscribing powder flow channel about the inner tip;
a detachable housing circumscribing the outer nozzle in spaced apart relationship to define a circumscribing shield gas flow channel about the outer nozzle;
a main body coupling the inner tip, the outer nozzle and the housing, the main body defining a central passage through which light may travel, the main body defining a powder flow conduit in communication with the powder flow channel, the main body defining a coolant channel coaxial with the central passage;
a detachable water jacket cover coupled to the main body and enclosing the coolant channel to prevent coolant leakage, the water jacket cover defining a powder tube depression through which a powder tube may pass and communicate with the powder flow conduit; and
a detachable porous shielding cover coupled to and circumscribing the outer nozzle, the porous shielding cover allowing gas to exit from the shield gas flow channel and preventing entry of material into the shield gas flow channel, the porous shielding cover circumscribed by and coupled to the housing.

6. A coaxial nozzle for laser powder fusion (LPF) welding, comprising:
a main body defining a central light passage through which light may pass through the main body, the main body defining a powder conduit through which powder may pass through the main body, the main body defining a coolant channel through which coolant may flow, the coolant channel coaxial with the central light passage and circumscribing the powder conduit;
a coolant jacket cover detachably attached to the main body and sealing the coolant channel, the coolant jacket defining an inlet and an outlet to the coolant channel;
an inner tip defining a first central open channel through which light may pass, the inner tip detachably attached to a terminal end of the main body, the inner tip coaxial with the central light passage of the main body;
an outer nozzle defining a second central open channel through which powder may pass, the outer nozzle detachably attached to the main body, the outer nozzle coaxial with the first central open channel of the inner tip and the central light passage of the main body, a powder flow channel defined between the outer nozzle and the inner tip in communication with the powder conduit;
an housing defining a third central open channel through which fluid may pass, the housing detachably attached to the main body, the housing coaxial with the second central open channel and the first central open channel and the central light passage, a shield gas flow channel defined between the outer nozzle and the housing; and
a detachable porous shielding cover circumscribing a terminal end of the outer nozzle and covering an open end of the shield gas flow channel.

7. A nozzle laser powder fusion welding, comprising:
a detachable and wear-resistant tip that resists damage arising from heat generated during operation, the tip having a first central light passage;
the nozzle defining a second central light passage aligned and communicating with the first central light passage;
the nozzle defining a powder flow passage circumscribing and coaxial with the central light passage;
the nozzle defining a shield gas flow passage circumscribing and coaxial with the powder flow passage and the central light passage; and
a detachable porous shielding cover covering an open end of the shield gas flow passage proximate the tip.

8. A nozzle for laser powder fusion welding as set forth in claim 7, further comprising:
a main body defining the second central light passage;
the main body defining a powder conduit in communication with the powder flow passage;
the main body defining a coolant channel at a top end thereof; and
a coolant jacket cover detachably attached to the top of the main body and sealing the coolant channel, the coolant jacket defining a coolant inlet and a coolant outlet.

9. A nozzle for laser powder fusion welding as set forth in claim 7, further comprising:
an outer nozzle detachably attached to the nozzle, the outer nozzle separating the powder flow passage from the shield gas flow passage, the outer nozzle directing powder flow to a focus point in front of the first central light passage.
